(19) United States
(12) Patent Application Publication
(10) Pub. No.: US 2017/0126296 A1
(43) Pub. Date: May 4, 2017

(54) System and Method for Large Scale Multiple Input Multiple Output Beamforming

(71) Applicant: Futurewei Technologies, Inc., Plano, TX (US)

(72) Inventors: Arkady Molev Shteiman, Bridgewater, NJ (US); Xiao Feng Qi, Westfield, NJ (US)

(21) Appl. No.: 14/932,849

(22) Filed: Nov. 4, 2015

(51) Int. Cl. H04B 7/06; H04B 17/20; H04B 7/04

(52) U.S. Cl. CPC H04B 7/0617; H04B 7/0413; H04B 17/20

(57) ABSTRACT

A method for operating a large scale multiple input multiple output (MIMO) communications device adapted to perform large scale MIMO communications includes determining beamforming coefficients for antennas of an antenna array in accordance with position information of antennas of the antenna array and directional information of a communications device with which the large scale MIMO communications device is communicating, applying the beamforming coefficients to the antennas of the antenna array, and communicating with the communications device using the antenna array.

### TECHNICAL FIELD

The present disclosure relates generally to digital communications, and more particularly to a system and method for large scale multiple input multiple output (MIMO) beamforming.

### BACKGROUND

In general, multiple input multiple output (MIMO) increases the capacity of a radio link through the use of multiple transmit antennas and multiple receive antennas. MIMO exploits multipath propagation to increase the capacity of the radio link. MIMO has proven to be effective at increasing the capacity of the radio link and has been accepted into a variety of technical standards, including WiFi or Wireless LAN: IEEE 802.11n, and IEEE 802.11ac; Evolved High-Speed Packet Access (HSPA+); Worldwide Interoperability for Microwave Access (WiMAX); and Third Generation Partnership Project (3GPP) Long Term Evolution (LTE) Advanced.

Increasing the number of transmit antennas and receive antennas from a relatively small number (on the order of 10 or fewer) to a significantly larger number (on the order of 100, 1000, 10000, or more) can lead to even greater increases in the capacity of the radio link.

Beamforming is a signal processing technique used for directional communications (signal transmission and/or reception). Beamforming involves combining antenna elements in such a way that some directions experience constructive interference while other directions experience destructive interference, therefore generating a communications beam in an intended direction.

### SUMMARY OF THE DISCLOSURE

Example embodiments provide a system and method for large scale multiple input multiple output (MIMO) beamforming.

In accordance with an example embodiment, a method for operating a large scale MIMO communications device adapted to perform large scale MIMO communications is provided. The method includes determining beamforming coefficients for antennas of an antenna array in accordance with position information of antennas of the antenna array and directional information of a communications device with which the large scale MIMO communications device is communicating, applying the beamforming coefficients to the antennas of the antenna array, and communicating with the communications device using the antenna array.

In accordance with another example embodiment, a large scale MIMO communications device is provided. The large scale MIMO communications device includes an antenna array, a processor, and a computer readable storage medium storing programming for execution by the processor. The programming including instructions configuring the large scale MIMO communications device to determine beamforming coefficients for antennas of the antenna array in accordance with position information of antennas of the antenna array and directional information of a communications device with which the large scale MIMO communications device is communicating, apply the beamforming coefficients to the antennas of the antenna array, and communicate with the communications device using the antenna array.

In accordance with another example embodiment, a large scale MIMO communications system is provided. The large scale MIMO communications system includes a positioning system, and a large scale MIMO communications device. The positioning system transmits orthogonal reference signals. The large scale MIMO communications device includes an antenna array comprising a plurality of antenna units, a processor, and a computer readable storage medium storing programming for execution by the processor. The programming including instructions configuring the large scale MIMO communications system to determining positional information of antenna units of the antenna array in accordance with the orthogonal reference signals transmitted by the positioning system, determining beamforming coefficients for the antenna units of the antenna array in accordance with the positional information and directional information of a communications device operating in a coverage area of the large scale MIMO communications system, applying the beamforming coefficients to the antenna units of the antenna array, and communicating with the communications device using the antenna array.

Practice of the foregoing embodiments enable beamforming in large scale MIMO communications systems with irregular antenna arrays.

Moreover, the embodiments provide for beamforming in large scale MIMO communications systems with irregular antenna arrays that change over time.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system highlighting MIMO reception according to example embodiments described herein;

FIG. 2 illustrates an example communications system highlighting MIMO transmission according to example embodiments described herein;

FIG. 3 illustrates a flow diagram of example operations occurring in a large scale MIMO communications device performing beamformed communications according to example embodiments described herein;

FIG. 4 illustrates a plurality of antenna beams according to example embodiments described herein;

FIG. 5 illustrates an example positioning system for determining the coordinates of an antenna using a TOA method according to example embodiments described herein;

FIG. 6A illustrates a top view of an example portable reference signal generating system according to example embodiments described herein;

FIG. 6B illustrates a side view of portable reference signal generating system according to example embodiments described herein;

FIG. 7A illustrates a one-dimensional large scale MIMO antenna according to example embodiments described herein;

FIG. 7B illustrates a two-dimensional large scale MIMO antenna according to example embodiments described herein;

FIGS. 8A and 8B illustrate example cross-sectional views of three-dimensional array configurations where the antennas in the antenna array are not planar or uniformly spaced according to example embodiments described herein;

FIG. 9 illustrates an example positioning system for determining the coordinates of antennas of an antenna array disposed on the skin of a lighter than air airship according to example embodiments described herein;

FIG. 10A illustrates an example coverage area of a communications system utilizing an antenna array disposed on the surface of a lighter than air airship according to example embodiments described herein;

FIG. 10B illustrates a data plot of coverage area size (in square kilometers) versus height (in kilometers) according to example embodiments described herein;

FIG. 10C illustrates an example coverage area of a communications system as described in FIG. 10A according to example embodiments described herein;

FIG. 11 illustrates an example MIMO communications device, highlighting the architecture of MIMO communications device according to example embodiments described herein;

FIG. 12 illustrates a detailed view of an example MIMO communications device, highlighting interconnections between components of MIMO communications device according to example embodiments described herein;

FIG. 13 illustrates a detailed view of an example AU according to example embodiments described herein;

FIG. 14 illustrates a block diagram of an embodiment processing system for performing methods described herein according to example embodiments described herein; and

FIG. 15 illustrates a block diagram of a transceiver adapted to transmit and receive signaling over a telecommunications network according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the embodiments and ways to operate the embodiments disclosed herein, and do not limit the scope of the disclosure.

One embodiment relates to large scale multiple input multiple output (MIMO) beamforming. For example, a large scale MIMO communications device determines beamforming coefficients for antennas of an antenna array in accordance with position information of antennas of the antenna array and directional information of a communications device with which the large scale MIMO communications device is communicating, applies the beamforming coefficients to the antennas of the antenna array, and communicates with the communications device using the antenna array.

The embodiments will be described with respect to example embodiments in a specific context, namely MIMO communications systems that support very beamforming with antenna arrays having large numbers of transmit antennas and receive antennas and irregular configurations. The embodiments may be applied to standards compliant FD communications systems, such as those that are compliant with Third Generation Partnership Project (3GPP), IEEE 802.11, WiMAX, HSPA, and the like, technical standards, and non-standards compliant MIMO communications systems, that support beamforming with antenna arrays having very large numbers of transmit antennas and receive antennas and irregular configurations.

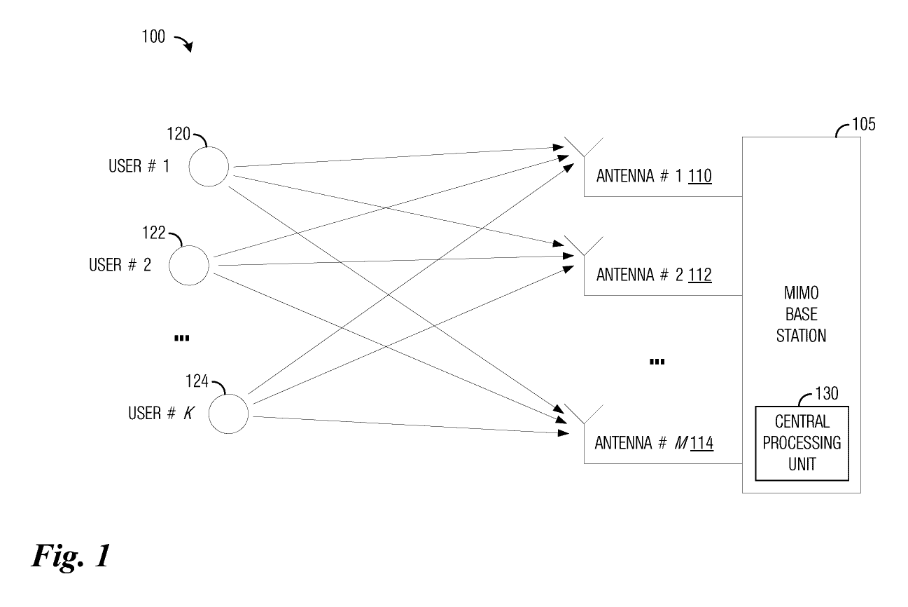

FIG. 1 illustrates an example communications system 100 highlighting MIMO reception. Communications system 100 includes a MIMO base station 105 serving K users, such as user #1 120, user #2 122, and user #K 124, where K is an integer number greater than or equal to 1. MIMO base station 105 includes M receive antennas, such as antenna #1 110, antenna #2 112, and antenna #M 114, where M is an integer number greater than or equal to 1. In a large scale MIMO implementation, M may be on the order of 100s, 1000s, 10000s, or even greater. A special case of large scale MIMO is referred to as massive MIMO. Massive MIMO may involve an extremely large number of antennas, 100000 or more. A base station may also be referred to as an access point, a NodeB, an evolved NodeB (eNB), a communications controller, and so on, while a user may also be referred to as a mobile station, a mobile, a terminal, a subscriber, a user equipment (UE), and so forth. MIMO base station 105 also includes a central processing unit 130 configured to estimate signals transmitted by the users and received by MIMO base station 105.

While it is understood that communications systems may employ multiple base stations capable of communicating with a number of users, only one base station, and a number of users are illustrated for simplicity.

In communications system 100, the K users share the same communications system resources (such as time-frequency resources). To simplify discussion, each user is equipped with only one antenna. However, the example embodiments presented herein are operable with users with any number of antennas. Each of the M receive antennas at MIMO base station 105 are equipped with its own radio frequency (RF) hardware (such as filters, amplifiers, mixers, modulators, demodulators, constellation mappers, constellation demappers, and the like), analog to digital (A/D) converters, digital to analog (D/A) converters, as well as a local processing unit that is capable of performing a limited amount of processing. The local processing unit, the antenna and the associated hardware may be referred to as an antenna unit (AU). The local processing unit is referred to herein as an AU processing unit.

Communications system 100 may be represented as a mathematical model expressible as:

$$[ \begin{matrix}{y}_{1} \\ {y}_{2} \\ \cdot \\ \cdot \\ \cdot \\ {y}_{M}\end{matrix} ] = [ \begin{matrix}{a}_{1 , 1} & {a}_{1 , 2} & … & {a}_{1 , K} \\ {a}_{2 , 1} & {a}_{2 , 2} & … & {a}_{2 , K} \\ \cdot & \cdot & & \cdot \\ \cdot & \cdot & & \cdot \\ \cdot & \cdot & & \cdot \\ {a}_{M , 1} & {a}_{M , 2} & … & {a}_{M , K}\end{matrix} ] \cdot [ \begin{matrix}{x}_{1} \\ {x}_{2} \\ \cdot \\ \cdot \\ \cdot \\ {x}_{K}\end{matrix} ] + [ \begin{matrix}{n}_{1} \\ {n}_{2} \\ \cdot \\ \cdot \\ \cdot \\ {n}_{M}\end{matrix} ] or$$

$$Y = A \cdot X + N$$

where X is a transmitted symbol vector of length K in which each element xₖ represents a data symbol associated with user k; Y is a received sample vector of length M in which each element yₘ represents a sample of receive antenna m; N is a receiver noise sample vector of length M in which each element nₘ represents the noise receive on receive antenna m, it is assumed that N is additive white Gaussian noise (AWGN); A is a channel matrix of size M by K in which each element a_{m,k} represents a channel transfer function between user k and receive antenna in; K is the number of users served by MIMO base station 105; and M is the number of receive antennas of MIMO base station 105. In general, a MIMO receiver has to resolve the above expression and given the received sample vector Y, find an estimate of the transmitted symbol vector X (denoted X) that is as close as possible to the transmitted symbol vector X.

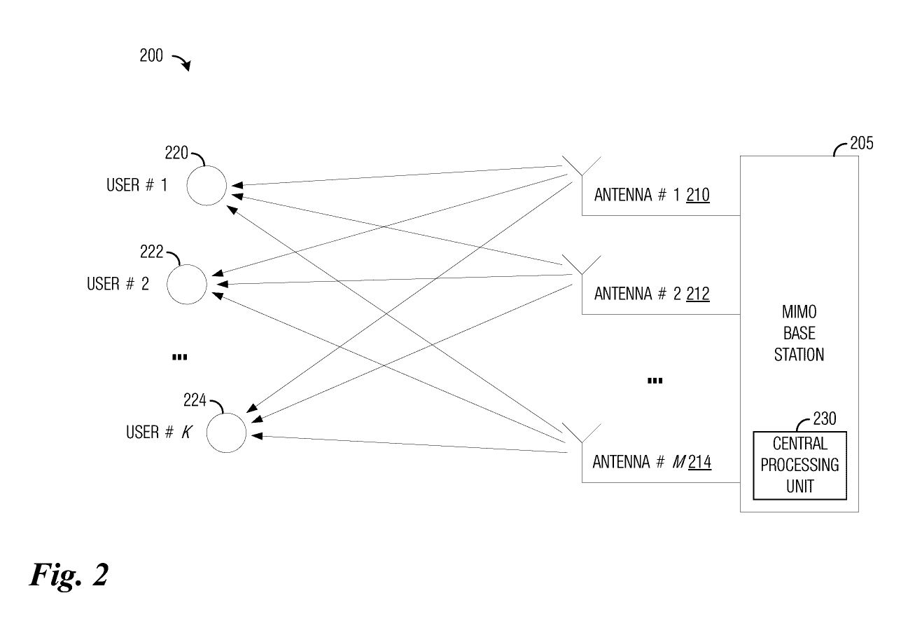

FIG. 2 illustrates an example communications system 200 highlighting MIMO transmission. Communications system 200 includes a MIMO base station serving K users, such as user #1 220, user #2 222, and user #K 224, where K is an integer number greater than or equal to 1. MIMO base station 205 includes M transmit antennas, such as antenna #1 210, antenna #2 212, and antenna #M 214, where M is an integer number greater than or equal to 2. In a large scale MIMO implementation, M may be on the order of 100s, 1000s, 10000s, or even greater. MIMO base station 205 also includes a central processing unit 230 configured to assist in precoding transmissions to the K users. Central processing unit 230 is also configured to assist in channel estimation.

Communications system 200 may be represented as a mathematical model expressible as:

$$[ \begin{matrix}{r}_{1} \\ {r}_{2} \\ \cdot \\ \cdot \\ \cdot \\ {r}_{K}\end{matrix} ] = [ \begin{matrix}{a}_{1 , 1} & {a}_{1 , 2} & … & {a}_{1 , M} \\ {a}_{2 , 1} & {a}_{2 , 2} & … & {a}_{2 , M} \\ \cdot & \cdot & & \cdot \\ \cdot & \cdot & & \cdot \\ \cdot & \cdot & & \cdot \\ {a}_{K , 1} & {a}_{K , 2} & … & {a}_{K , M}\end{matrix} ] \cdot [ \begin{matrix}{w}_{1 , 1} & {w}_{1 , 2} & … & {w}_{1 , M} \\ {w}_{2 , 1} & {w}_{2 , 2} & … & {w}_{2 , M} \\ \cdot & \cdot & & \cdot \\ \cdot & \cdot & & \cdot \\ \cdot & \cdot & & \cdot \\ {w}_{M , 1} & {w}_{M , 2} & … & {w}_{M , K}\end{matrix} ] \cdot [ \begin{matrix}{x}_{1} \\ {x}_{2} \\ \cdot \\ \cdot \\ \cdot \\ {x}_{K}\end{matrix} ]$$

$$or R = A \cdot W \cdot X + N ,$$

where X is a transmitted symbol vector of length K in which each element xₖ represents a symbol of user k; R is a received sampled vector of length K in which each element rₖ represents a sample received by user k; N is a received noise vector of length K in which each element nₖ represents noise received by user k (it is assumed that N is AWGN); A is a channel matrix of size M by K in which each element a_{m,k} represents the channel transfer function between user k and transmit antenna m; and W is a precoding matrix of size K by M.

As discussed previously, beamforming is a signal processing technique used for directional communications (signal transmission and/or reception). Beamforming involves combining antenna elements in such a way that some directions experience constructive interference while other directions experience destructive interference, therefore generating a communications beam in an intended direction. Therefore, in order to utilize beamforming, a communications device needs to obtain directional information regarding other communications devices with which it is communicating. From the directional information, the communications device may be able to generate antenna coefficients to generate communications beams directed towards the other communications devices.

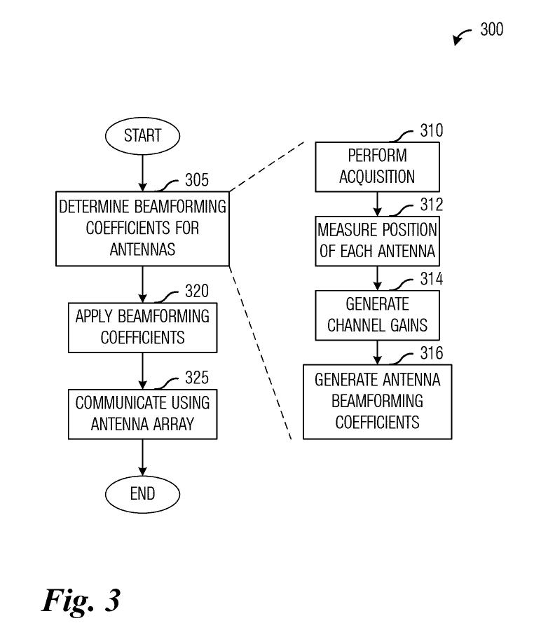

FIG. 3 illustrates a flow diagram of example operations 300 occurring in a large scale MIMO communications device performing beamformed communications. Operations 300 may be indicative of operations occurring in a large scale MIMO communications device performing beamformed communications.

Operations 300 begin with the large scale MIMO communications device generating beamforming coefficients for the antennas of the antenna array (block 305). The generation of the beamforming coefficients may include the large scale MIMO communications device performing acquisition to obtain directional information regarding other communications devices with which it is communicating (block 310), measuring positions for each of the antennas in the antenna array (block 312), determining channel gains for channels between the antennas and the other communications devices (block 314), and generating the antenna beamforming coefficients based on the channel gains (block 316). Detailed discussions of the measuring of the positions for each of the antennas in the antenna array, the generating of the channel gains, and the generating of the antenna beamforming coefficients are provided below.

The large scale MIMO communications device applies the beamforming coefficients (block 320). Applying the beamforming coefficients may involve providing appropriate beamforming coefficients to the antennas of the antenna array. The large scale MIMO communications device communicates with the other communications devices using the antenna array (block 325). The large scale MIMO communications device may transmit using the antenna array, receive using the antenna array, or a combination of both.

Typically, performing acquisition to obtain directional information involves the large scale MIMO communications device using an antenna array to scan over a search space using communications beams to measure received energy from the other communications devices. The large scale MIMO communications device may select a number of communications beams corresponding to measured received energy exceeding a specified threshold. The selected communications beams correspond to the directions of the other communications devices. Normally, the acquisition process may be slow since the large scale MIMO communications device may have a large number of communications beams with which to scan the search space. Furthermore, when the antenna array of the large scale MIMO communications device has a large number of antennas, the communications beams generated by the antenna array are narrow, which may require the large scale MIMO communications device to use a large number of communications beams to fully scan the search space. In a co-assigned U.S. Patent Application entitled “System and Method for Large Scale Multiple Input Multiple Output Communications”, attorney docket number HW 84543089US01, which is hereby incorporated herein by reference, a fast acquisition technique is presented which helps to speed up the acquisition process by partitioning the search space and the antenna array. In the fast acquisition technique, different portions of the antenna array are assigned to scan different parts of the search space. Reducing the size of the search space affords a reduction in the time required to scan the search space. An additional reduction in the scanning time is obtained due to the wider communications beams generated by the smaller number of antennas in each portion of the antenna array; the wider communications beams help to speed up the scan of the search space. Therefore, the combination of the smaller search space and the wider communications beams significantly shortens the acquisition time.

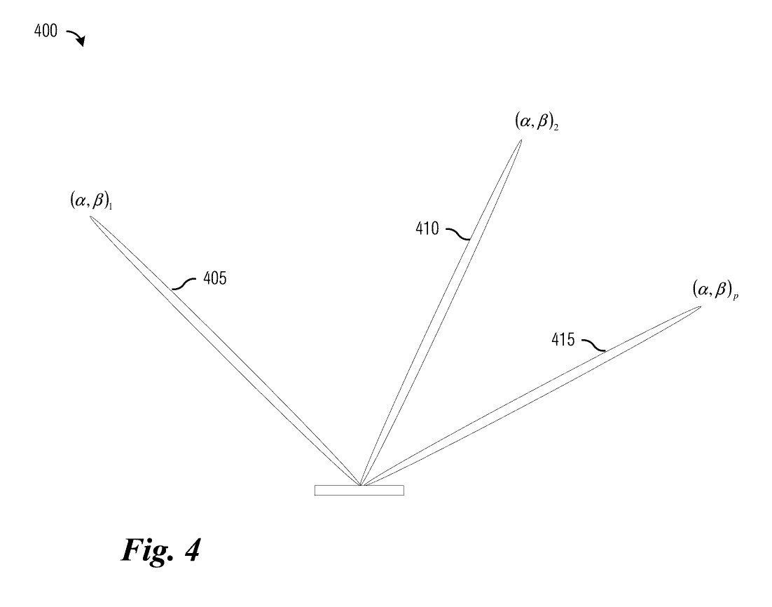

FIG. 4 illustrates a plurality of antenna beams 400. Plurality of antenna beams 400 may be illustrative of communications beams found during an acquisition process. Plurality of antenna beams 400 may include antenna beam 405 with direction (α, β)₁, antenna beam 410 with direction (α, β)₂, and antenna beam 415 with direction (α, β)₃. The directions (α, β) may be referred to as the directional information.

According to an example embodiment, a time of arrival (TOA) method is used to determine coordinates of each antenna in an antenna array. TOA is a technique that is used in positioning systems, such as Global Positioning System (GPS). TOA uses delays in received reference signals transmitted by a plurality of reference signal generators to determine the position of an antenna that received the reference signals.

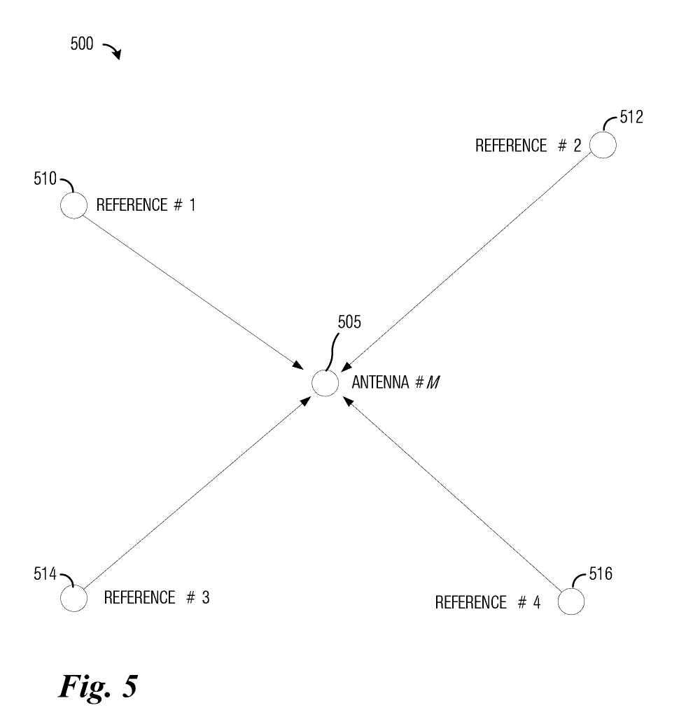

FIG. 5 illustrates an example positioning system 500 for determining the coordinates of an antenna using a TOA method. Positioning system 500 is configured to determine the position of an antenna M 505 of an antenna array. Positioning system 500 includes a plurality of reference signal generators, such as reference signal generator #1 510, reference signal generator #2 512, reference signal generator #3 514, and reference signal generator #4 516. The positions of the reference signal generators are known. Although positioning system 500 includes 4 reference signal generators, it is possible to determine the position of an antenna using 4 or more reference signal generators. Generally, the more reference signal generators being used in a positioning system, the more accurate the results.

Reference signal generators transmit orthogonal reference signals that individually arrive at antenna M 505 with different delay. The delays associated with the reference signals are expressible as

c²·(τₘ⁰−tₘ)²=(X₀−xₘ)²+(Y₀−yₘ)²+(Z₀−zₘ)²

c²·(τₘ¹−tₘ)²=(X₁−xₘ)²+(Y₁−yₘ)²+(Z₁−zₘ)²

c²·(τₘ²−tₘ)²=(X₂−xₘ)²+(Y₂−yₘ)²+(Z₂−zₘ)^{2′}

c²·(τₘ³−tₘ)²=(X₃−xₘ)²+(Y₃−yₘ)²+(Z₃−zₘ)²

where (Xₖ, Yₖ, Zₖ) is the coordinates of a k-th reference signal generator, (xₘ, yₘ, zₘ) is the unknown coordinates of antenna M 505, tₘ is an unknown time offset of antenna M 505, τₘ^{k} is a time of arrival of reference signals sent by reference signal generator k at antenna M 505, and c is the speed of light. Since there are 4 equations and 4 unknowns (xₘ, yₘ, zₘ, tₘ), it is possible to solve for the 4 unknowns to determine the coordinates of antenna M 505 and the time offset for antenna M 505 (xₘ, yₘ, zₘ, tₘ).

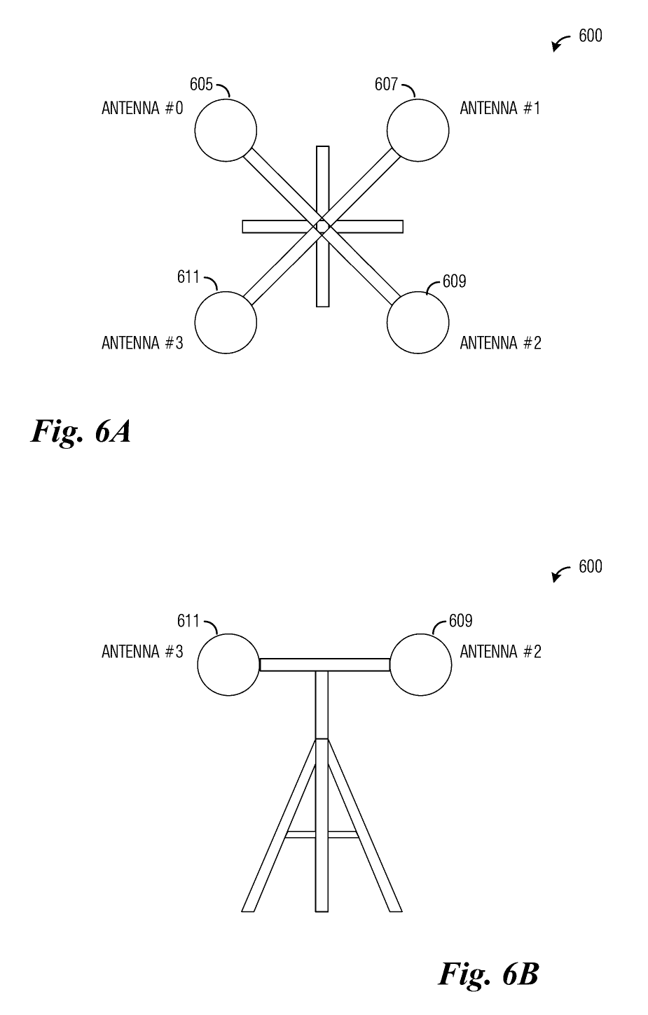

In an outdoor deployment, it may be possible to use an existing positioning system, such as GPS, for example, to determine the positions of the antennas in an antenna array. However, in an indoor deployment where GPS signals have trouble penetrating walls, a portable reference signal generating system may be used. FIGS. 6A illustrates a top view of an example portable reference signal generating system 600. Portable reference signal generating system 600 includes 4 antennas, including antenna 605, antenna 607, antenna 609, and antenna 611. Each of the 4 antennas is configured to send orthogonal reference signals. FIG. 6B illustrates a side view of portable reference signal generating system 600. In the side view shown in FIG. 6B, antennas 609 and 611 obscure views of antennas 605 and 607.

According to an alternative example embodiment, if the positions of 4 or more of the antennas of an antenna array are known, the 4 or more antennas are used as reference signal generators and send orthogonal reference signals to be used to determine the positions of the remaining antennas of the antenna array.

Since the antennas of the antenna array are usually in a constant location or moving very slowly, the antenna array is stable. Therefore, there is not a problem with antenna position determining precision. The determining of the position of the antennas may be performed during a wake up, initialization, or re-initialization process. Hence, there are typically no strict time limits on determining the positions of the antennas of the antenna array. The relatively relaxed time constraints may enable position estimation averaging over an extended amount of time in order to obtain a desired level of precision, with position estimation precision increasing with increased averaging time.

According to an example embodiment, the channel gains are determined for the antennas in the antenna array based on the positions of the antennas and the directional information. The channel gains are determined for channels from each of the antennas in the antenna array to each of the other communications devices.

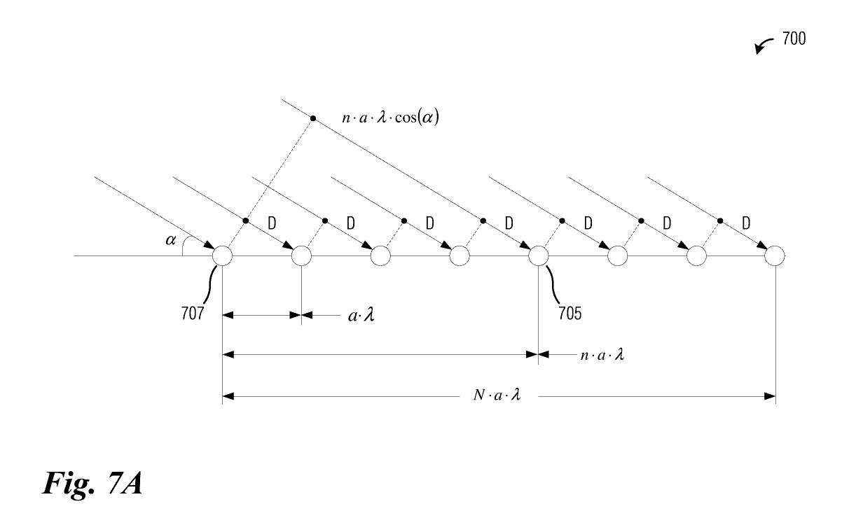

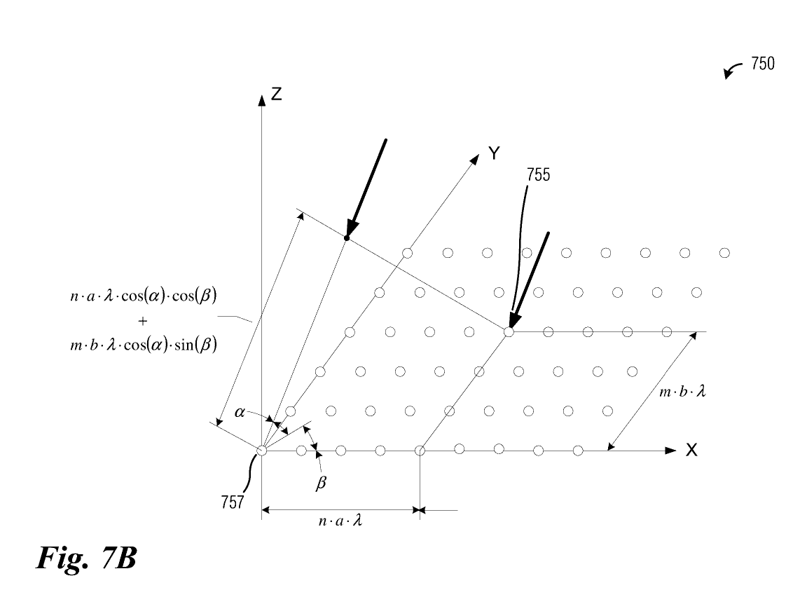

In a typical large scale MIMO implementation, a large number (M×N) omni-directional antennas are mounted on a flat surface with a consistent spacing between antennas (a·λ×b·λ), where N and M are integer values and l is wavelength of a signal. FIG. 7A illustrates a one-dimensional large scale MIMO antenna 700. In such a configuration, an antenna #n 705 has coordinate (n·a·λ, 0) in plane (x, y) centered at antenna #0 707 when the spacing between consecutive antennas is a·λ. If a beam arrives at one-dimensional MIMO antenna 700 with angle α, the beam arrives at antenna #n with a delay that is equal to a length of an orthogonal projection of a normalized vector D with angle α and the coordinate of antenna #n 705 divided by the speed of light c, which is expressible as

$${t}_{n} = \frac{{D}_{n}}{c} = n \cdot \frac{D}{c} = n \cdot \frac{a \cdot λ}{c} \cdot cos ( α ) .$$

Therefore, the beam arrives at antenna #n 705 with a complex gain expressible as

$${H}_{n} ( α ) = exp ( j \cdot 2 \cdot π \cdot \frac{c \cdot {t}_{n}}{λ} ) = ( j \cdot 2 \cdot π \cdot n \cdot a \cdot cos ( α ) ) .$$

Hence, antenna arrays that are tuned to the receive the signal from direction α may be configured with coefficients that match the complex gain H*ₙ(α).

FIG. 7B illustrates a two-dimensional large scale MIMO antenna 750. In such a configuration, an antenna (n, m) 755 has coordinates (n·a·λ, n·b·λ, 0) in space (x, y, z) centered at antenna (0, 0) 757, where a and b are spacing constants. If a beam arrives at two-dimensional MIMO antenna 750 with angle (α, β), the beam arrives at antenna (n, m) 755 with a delay that is equal to a length of an orthogonal projection of a normalized vector with angle (α, β) and the coordinates of antenna (n, m) 755 divided by the speed of light c, expressible as

$${t}_{n , m} = \frac{{D}_{n , m}}{c} = n \cdot \frac{a \cdot λ}{c} \cdot cos ( α ) \cdot cos ( β ) + m \cdot \frac{b \cdot λ}{c} \cdot cos ( α ) \cdot sin ( β ) .$$

Therefore, the beam arrives at antenna (n, m) 755 with a complex gain expressible as

$$\begin{matrix} {H}_{n , m} ( α , β ) = exp ( j \cdot 2 \cdot π \cdot \frac{c \cdot {t}_{n , m}}{λ} ) & \\ or & \\ {H}_{n , m} ( α , β ) = exp ( j \cdot 2 \cdot π \cdot ( n \cdot a \cdot cos ( α ) \cdot cos ( β ) + m \cdot b \cdot cos ( α ) \cdot sin ( β ) ) ) . & \end{matrix}$$

Hence, antenna arrays that are tuned to the receive the signal from direction (a, 13) may be configured with coefficients that match the complex gain H*ₙ(α).

The antennas of the large scale MIMO antenna arrays discussed in FIGS. 7A and 7B are arranged in linear or planar arrays with uniform spacing between antennas. In such a situation, the total number of antennas in the antenna array is P=N×M and each antenna (n, m) has coordinates (n·a·λ, m·b·Λ, 0) in space (x, y, z). The classical beamforming equation is expressible as

H_{n,m}(α, β)=exp(j·2π·(n·a·cos(α)·cos(β)+m·b·cos(α)·sin(β))).

Therefore, the channel for antenna (n, m) located at

$$( {x}_{n , m} = n \cdot \frac{λ}{2} , {y}_{n , m} = m \cdot \frac{λ}{2} , {z}_{n , m} = 0 )$$

is expressible as

$${H}_{n , m} = {\sum }_{k = 0}^{K - 1} {G}_{k} \cdot exp ( j \cdot π \cdot ( n \cdot cos ( {α}_{k} ) \cdot cos ( {β}_{k} ) + m \cdot cos ( {α}_{k} ) \cdot sin ( {β}_{k} ) ) ) ,$$

where Gₖ is the complex amplitude of beam k.

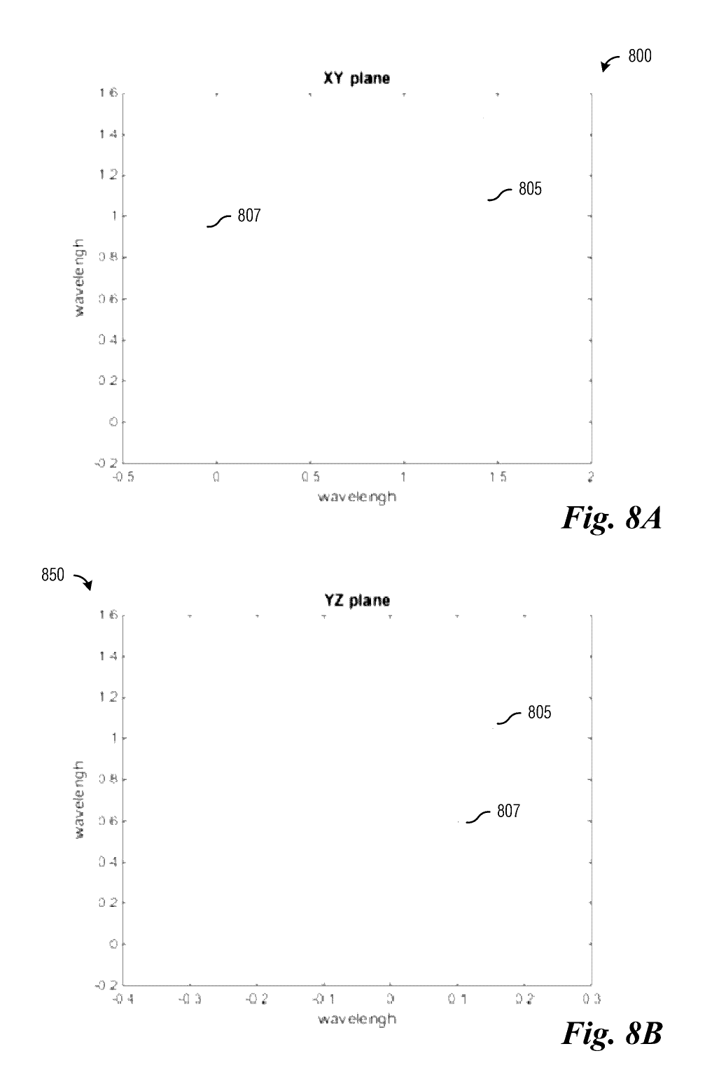

However, the antennas in the antenna array do not have to be in a plane, nor does the antenna spacing have to be uniform. For discussion purposes, consider a situation wherein a large scale MIMO communications device has an antenna array with P antennas where the antennas are located at a set of coordinates (x, y, z)ₚ. FIGS. 8A and 8B illustrate example cross-sectional views of three-dimensional array configurations where the antennas in the antenna array are not planar or uniformly spaced. FIG. 8A illustrates a view 800 of the antenna array taken along an X-Y plane and FIG. 8B illustrates a view 850 of the antenna array taken along a Y-Z plane. Included in FIGS. 8A and 8B are two example antennas 805 and 807 and their potential locations in the two views.

According to the definition of a far field, in order to determine the coefficients for the antennas for direction (α, β), the distance from the antenna array to the target in direction (α, β) must be at least an order of magnitude greater than the size of the antenna array. The coordinates of the target are expressible as

x_{T}=R·cos(α)·cos(β),

y_{T}=R·cos(α)·sin(β),

z_{T}=R·sin(α),

where R is at least an order of magnitude greater than \sqrt{xₚ²+yₚ²+zₚ²} for any antenna p. It may be shown that the complex gain of each antenna p is expressible as

$${H}_{p} ( α , β ) = exp ( j \cdot 2 \cdot π \cdot \frac{\sqrt{{( {x}_{p} - {x}_{T} )}^{2} + {( {y}_{p} - {y}_{T} )}^{2} + {( {z}_{p} - {z}_{T} )}^{2}}}{λ} ) ,$$

which may be normalized as

$${\overline{H}}_{p} ( α , β ) = {lim}_{R \to ∞} ( \frac{{H}_{p} ( α , β )}{{H}_{0} ( α , β )} ) .$$

It can also be shown that H̅ₚ(α, β) converges to a projection of unit vector (α, β) upon vector (xₚ−x₀, yₚ−y₀, zₚ−z₀), which is expressible as

$${\overline{H}}_{p} ( α , β ) = exp ( j \cdot 2 \cdot π \cdot \frac{\begin{matrix}( {x}_{p} - {x}_{0} ) \cdot cos ( α ) \cdot cos ( β ) + \\ ( {y}_{p} - {y}_{0} ) \cdot cos ( α ) \cdot sin ( β ) + ( {z}_{p} - {z}_{0} ) \cdot sin ( α )\end{matrix}}{λ} ) .$$

Therefore, the channel for antenna m located at (xₘ, yₘ, zₘ) is expressible as

$${H}_{m} = {\sum }_{k = 0}^{K - 1} {G}_{k} \cdot exp ( j \cdot 2 \cdot π \cdot \frac{\begin{matrix}{x}_{m} \cdot cos ( {α}_{k} ) \cdot cos ( {β}_{k} ) + {y}_{m} \cdot cos ( {α}_{k} ) \cdot \\ sin ( {β}_{k} ) + {z}_{m} \cdot sin ( {α}_{k} )\end{matrix}}{λ} )$$

where Gₖ is the complex amplitude of beam k and antenna 0 is located at reference point (x₀, y₀, z₀)

A received sample of antenna in at time t is expressible as

Yₘ(t)=Hₘ·D(t)+Noiseₘ(t),

where Noiseₘ(t) is the thermal noise of antenna in at time t, and D(t) is the data symbol at time t, which also can be re-written as

$${Y}_{m} ( t ) = {\sum }_{k = 0}^{K - 1} {G}_{k} \cdot exp ( j \cdot 2 \cdot π \cdot \frac{( {x}_{m} \cdot cos ( {α}_{k} ) \cdot cos ( {β}_{k} ) + {y}_{m} \cdot cos ( {α}_{k} ) \cdot sin ( {β}_{k} ) + {z}_{m} \cdot sin ( {α}_{k} )}{( λ )} ) \cdot D ( t ) + {Noise}_{m} ( t ) .$$

Using multi-beam maximum ratio combining (MRC) decoding, an output at time t of a MRC decoder is expressible as

$$R ( t ) = \frac{1}{{\sum }_{m = 0}^{M - 1} {\vert {H}_{m} \vert}^{2}} \cdot {\sum }_{m = 0}^{M - 1} conj ( {H}_{m} ) \cdot {Y}_{m} ( t ) = D ( t ) + Noise ( t ) ,$$

which also can be re-written as

$$R ( t ) = \frac{1}{{\sum }_{k = 0}^{K - 1} {{G}_{k}}^{2}} \cdot {\sum }_{k = 0}^{K - 1} conj ( {G}_{k} ) \cdot {R}_{k} ( t , {α}_{k} , {β}_{k} ) ,$$

where Rₖ(t, αₖ, βₖ) is the MRC decoder output for beam k at time t, which is expressible as

$${R}_{k} ( t , {α}_{k} , {β}_{k} ) = \frac{1}{M} \cdot {\sum }_{m = 0}^{M - 1} exp \\ ( - j \cdot 2 \cdot π \cdot \frac{( {x}_{m} \cdot cos ( {α}_{k} ) \cdot cos ( {β}_{k} ) + {y}_{m} \cdot cos ( {α}_{k} ) \cdot sin ( {β}_{k} ) + {z}_{m} \cdot sin ( {α}_{k} )}{( λ )} ) \cdot {Y}_{m} ( t ) .$$

Utilizing the expressions for Rₖ(t, αₖ, βₖ) and Yₘ(t) above, and since the beams are orthogonal to each other, it may be shown that the MRC decoder output for beam k at time t is approximately equal to the data symbol at time t multiplied by the complex amplitude of beam k: Rₖ(t, αₖ, βₖ)≈Gₖ·D(t). Suppose that the pilot sequence of length N is known (i.e., D(t)=PLT(t) For (0≦t≦N)), then the Least Mean Squared (LMS) complex gain estimation is expressible as

$${\hat{G}}_{k} = \frac{1}{N} \cdot {\sum }_{n = 0}^{N - 1} {R}_{k} ( n , {α}_{k} , {β}_{k} ) \cdot PLT ( n ) \approx {G}_{k} .$$

The expression for Hₚ(α, β) and H̅ₚ(α, β) above shows that it is possible to tune the antenna array with antennas at coordinates (x,y,z)ₚ in space (x, y, z) to transmit and/or receive signals to and/or from direction (α, β) may be configured with coefficients that match the complex gain H*ₚ(α, β).

The antenna array, which may be non-planar with non-uniform antenna spacing, may also be non-rigid. Being non-rigid means that the antennas in the antenna array may move or otherwise change position as a function of time. Although the antennas in the antenna array may move, reference signal generators (such as shown in FIG. 5 and described previously) can assist in compensating for the movement of the antennas and keep the communications beams of the antenna oriented in the proper directions. As an illustrative example, the antenna array may be attached on the skin of a lighter than air airship, such as a zeppelin.

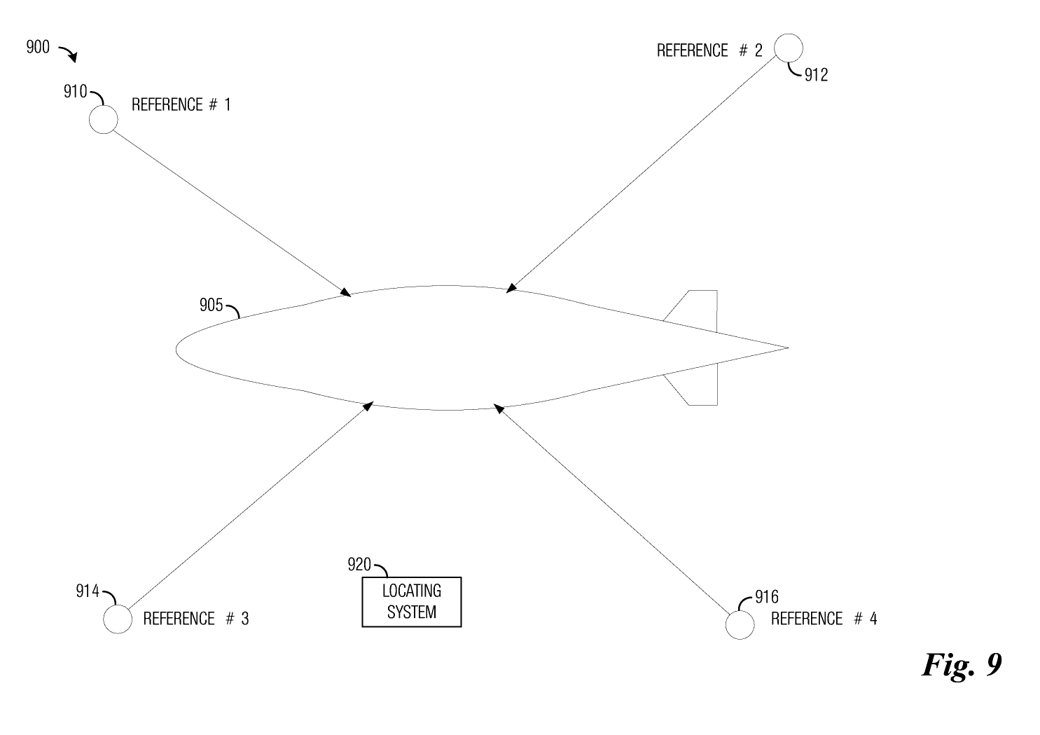

FIG. 9 illustrates an example positioning system 900 for determining the coordinates of antennas of an antenna array disposed on the skin of a lighter than air airship. Positioning system 900 is configured to determine the position of an airship 905. Positioning system 900 includes a plurality of reference signal generators, such as reference signal generator #1 910, reference signal generator #2 912, reference signal generator #3 914, and reference signal generator #4 916. The plurality of reference signal generators may radiate airship 905 with a plurality of orthogonal reference signals, e.g., four orthogonal reference signals. Positioning system 900 may operate in a manner similar to positioning system 500 of FIG. 5. Since airship 905 may move, a locating system 920, such as ground to air radar or a global positioning system may be used to help keep track of the position of airship 905 and help ensure that the plurality of reference signal generators provide good reference signal coverage of airship 905.

According to an example embodiment, the surface area of a lighter than air airship provides for a very large antenna array that is usable in implementing a communications system with extremely narrow communications beams. As discussed previously, a beamwidth of a communications beam is inversely proportional to the number of antennas of the antenna array. Furthermore, the communications beam will have a very large antenna gain that compensates for long distance losses.

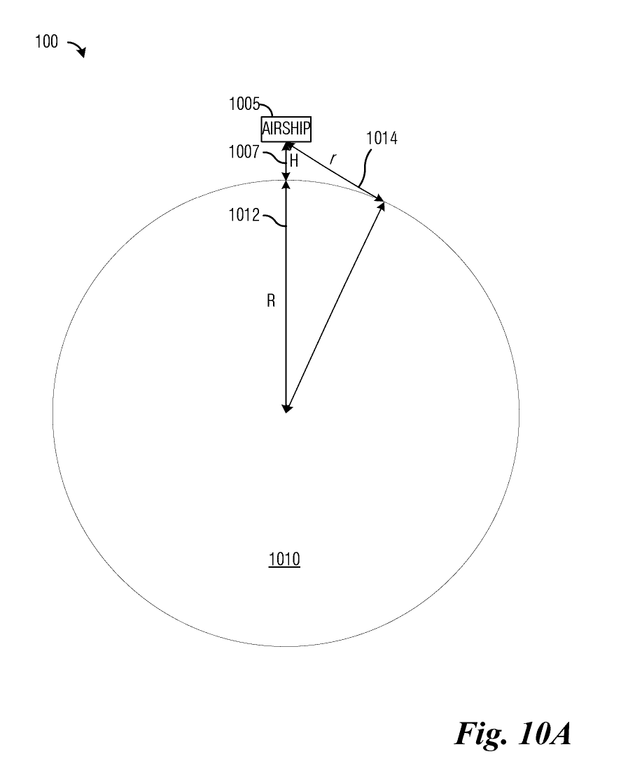

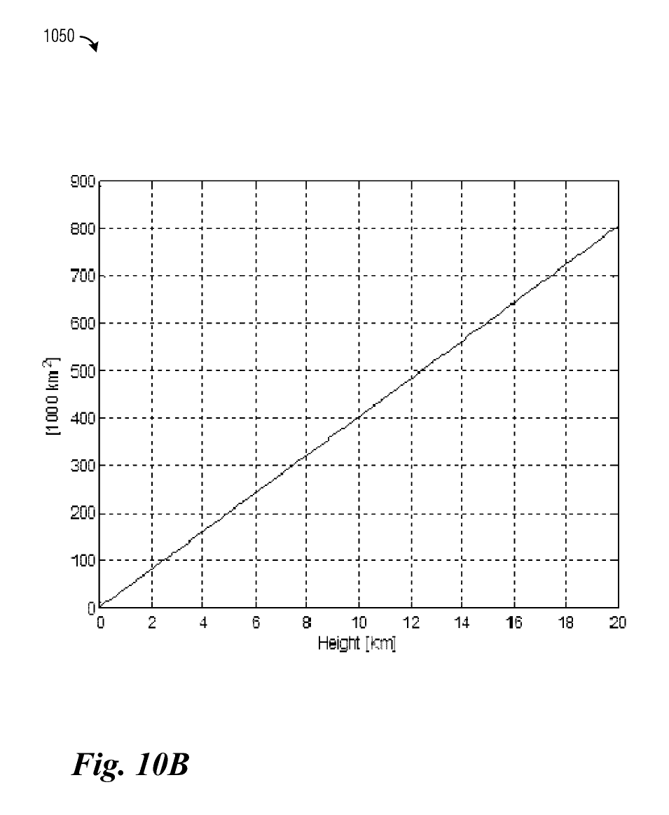

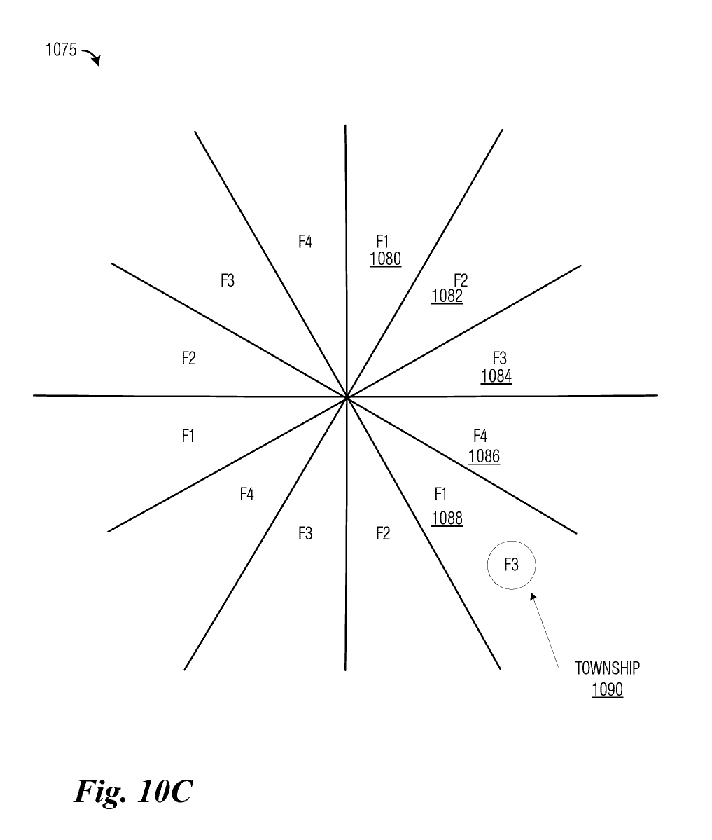

According to an example embodiment, a very large antenna array disposed on the surface of a lighter than air airship provides coverage for state-sized areas. The extremely narrow communications beams, coupled with very large antenna gains, may allow for communications system with a coverage area on the order of a hundred thousand or more square miles. FIG. 10A illustrates an example coverage area 1000 of a communications system utilizing an antenna array disposed on the surface of a lighter than air airship. As shown in FIG. 10A, an airship 1005 is positioned a distance H 1007 above planet Earth 1010, which has a radius R 1012. At height H, airship 1005 is able to utilize line-of-sight communications in a coverage area with radius r 1014. Such a communications system may be implemented in rural environments where typical base stations would be cost prohibitive. FIG. 10B illustrates a data plot 1050 of coverage area size (in square kilometers) versus height (in kilometers). As an example, if the airship is 10 kilometers above the surface of planet Earth, the resulting communications system will have a coverage area of about 400 thousand square kilometers.

FIG. 10C illustrates an example coverage area 1075 of a communications system as described in FIG. 10A. Coverage area 1075 may be sectorized. As shown in FIG. 10C, coverage area 1075 is divided into 12 sectors (including sectors 1080, 1082, 1084, 1086, and 1088), and communications beam frequencies are reused to help increase resource utilization and reduce interference. The sectors may be served by different communications beams, such as sector 1080 served by communications beam frequency F1, sector 1082 served by communications beam frequency F2, sector 1084 served by communications beam frequency F3, and sector 1086 served by communications beam frequency F4. The service pattern of the communications beam frequencies may be repeated in a cyclic manner as shown in FIG. 10C. Different service pattern cycles are also possible.

The communications system as described in FIG. 10A may also coexist with existing cellular communications networks. As shown in FIG. 10C, township 1090 is served by a cellular communications network utilizing frequency F3. As long as sector 1088 which encompasses township 1090 uses a different communications beam frequency (as shown in FIG. 10C, communications beam frequency F1 is used in sector 1088 while frequency F3 is used in the cellular communications network) from that used by the cellular communications network, interference does not occur between transmissions occurring in sector 1088 and the cellular communications network serving township 1090. If the cellular communications network spans several sectors, interference can still be avoided by having the sectors encompassing the cellular communications network use frequencies different from those used in the cellular communications network.

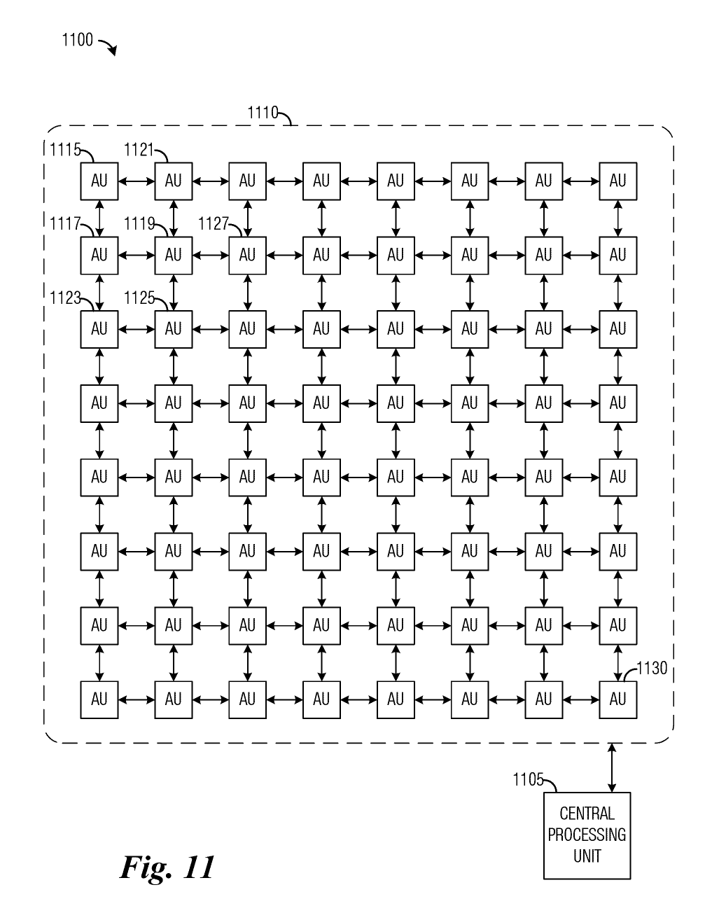

FIG. 11 illustrates an example MIMO communications device 1100, highlighting the architecture of MIMO communications device 1100. MIMO communications device 1100 includes a central processing unit 1105 and an array of antenna units (AUs) 1110 coupled to central processing unit 1105. Array of AUs 1110 may include any number of AUs, but for large scale MIMO implementations, it is expected that array of AUs 1110 includes on the order of hundreds, thousands, tens of thousands, or more AUs. Central processing unit 1105 may be a single processor or a multi-processor system. Not shown in FIG. 11 are ancillary circuitry such as memories, network interfaces, user interfaces, power supplies, and so forth.

Array of AUs 1110 may be arranged in a mesh configuration. Each AU in array of AUs 1110 is connected to a subset of neighboring AUs. As an illustrative example, AU 1115 is located at a vertex and is connected to two neighboring AUs (AU 1117 and AU 1121). While AU 1117 is located on an edge and is connected to three neighboring AUs (AU 1115, AU 1119, and AU 1123) and AU 1119 is located in a field of AUs and is connected to four neighboring AUs (AU 1117, AU 1121, AU 1125, and AU 1127). The AUs in array of AUs 1110 may be connected to central processing unit 1105 by one or more buses. Alternatively, central processing unit 1105 may be connected to a subset of the AUs in array AUs 1110. As an illustrative example, array of AUs 1110 may include an end AU 1130 that is connected to a subset of neighboring AUs (two neighboring AUs as shown in FIG. 11) and central processing unit 1105. Alternatively, the AUs may be arranged in a linear configuration or a tree configuration.

The AUs in array of AUs 1110 may be spaced regularly apart from one another, e.g., the AUs (or the antennas therein) are spaced one-half wavelength apart. Alternatively, the AUs in array of AUs 1110 may be irregularly spaced apart from one another, e.g., some AUs may be spaced regularly apart while others may be irregularly spaced apart, or none of the AUs are spaced apart by the same amount. The AUs in array of AUs 1110 may be planar (where all of the AUs lie in a single plane) or non-planar (where at least some of the AUs lie in different planes).

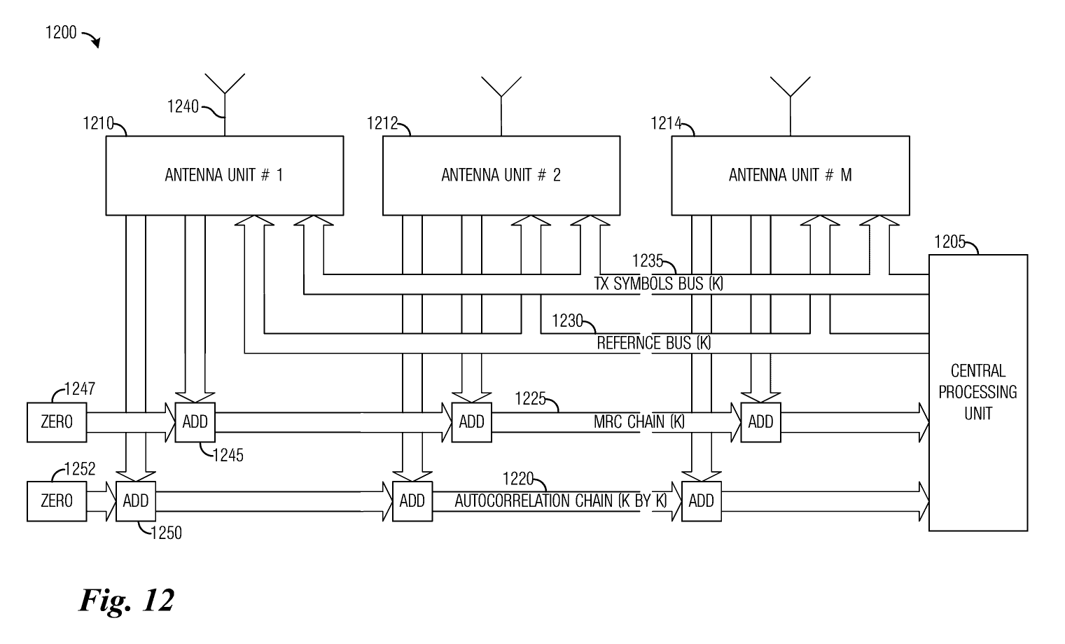

FIG. 12 illustrates a detailed view of an example MIMO communications device 1200, highlighting interconnections between components of MIMO communications device 1200. MIMO communications device 1200 includes a central processing unit 1205 connected to a plurality of AUs (such as AU 1210, AU 1212, and AU 1214), wherein the plurality of AUs may be arranged in an array of AUs but are shown as a linear sequence to simplify the figure. Central processing unit 1205 is connected to the plurality of AUs with an autocorrelation connection 1220 (used to exchange autocorrelation matrices), a maximum ratio combining (MRC) connection 1225 (used to exchange MRC vectors), a reference connection 1230 (used to exchange reference signals), and a TX symbols connection 1235 (used to exchange TX symbols to be transmitted).

Autocorrelation connection 1220 allows for the exchange of the accumulated autocorrelation matrix and has sufficient bandwidth to support the transfer of K by K-sized matrices. MRC connection 1225 allows for the exchange of the accumulated MRC vector and has sufficient bandwidth to support the transfer of K-sized vectors. Reference connection 1230 allows for the exchange of reference signals for use in channel estimation and has sufficient bandwidth to support the transfer of K-sized vectors. TX symbols connection 1235 allows for the exchange of TX symbols for transmission precoding and transmission and has sufficient bandwidth to support the transfer of K-sized vectors. The connections may be bi-directional in nature, allowing the AUs in the plurality of AUs to exchange information with one another. A control bus allows for the exchange of control signals regulating the operation of MIMO communications device.

MIMO communications device 1200 includes a plurality of adders (such as adders 1245 and 1250) to accumulate information from neighboring AUs. As shown in FIG. 12, information, after accumulation in a first adder is provided as input to a second adder associated with a neighboring AU. Adders associated with a first AU (i.e., AU 1210) are provided with zeroes as input by zeroes 1247 and 1252. Each AU also includes antennas (such as antenna 1240 for AU 1210). Although shown in FIG. 12 as a single antenna, each AU includes a receive antenna and a transmit antenna, which may be implemented as a single antenna with a duplexer or as two distinct antennas.

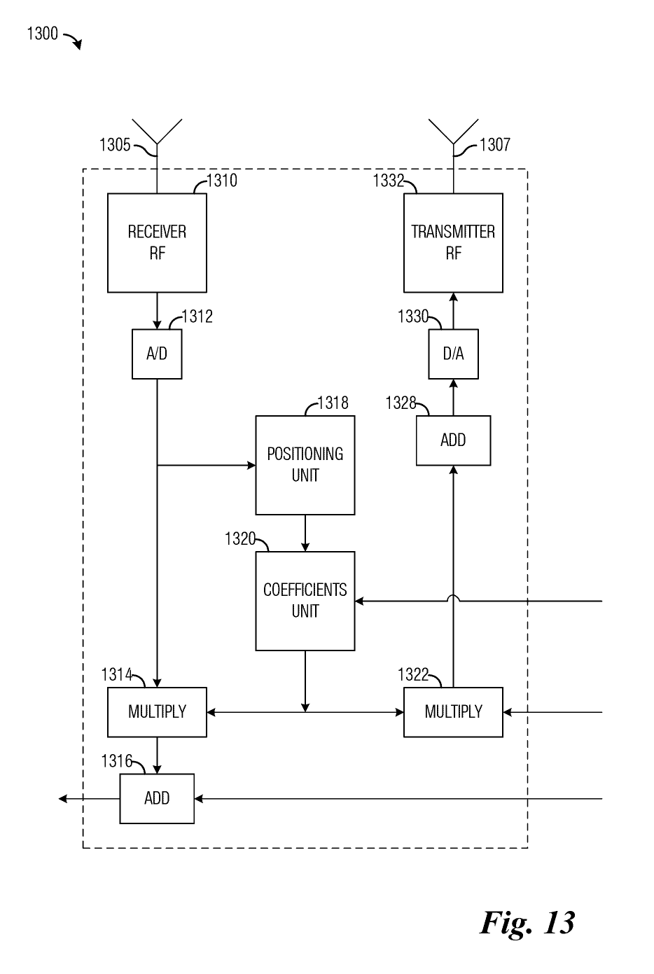

FIG. 13 illustrates a detailed view of an example AU 1300. AU 1300 includes a receive antenna 1305 and a transmit antenna 1307, although it is possible to share a single antenna through the use of a duplexer. AU 1300 also includes receiver RF circuitry 1310, which may include filters, demodulators, constellation demappers, and the like, and an A/D converter 1312. A multiply unit 1314 is configured to multiply received signals with coefficients provided by a coefficients unit 1320. As an illustrative example, the received signals may be multiplied by a reference signal, or a channel matrix. An adder 1316 is configured to accumulate results of multiplier 1316 along with shared information provided by a neighboring AU. The accumulated result of adder 1316 may be shared with another neighboring AU or with a central processing unit.

A positioning unit 1318 is configured to assist in determining a position of AU 1300 using received reference signals (such as those transmitted by positioning systems 500 and 900), while a multiply unit 1322 is configured to multiply coefficients provided by coefficients unit 1320 with signals provided by the central processing unit. As an illustrative example, multiply unit 1322 may multiply transmission symbols provided by the central processing unit with channel transfer functions. An adder 1328 combines the outputs of multiplier 1328 and provides the combine value to a D/A converter 1320. AU 1300 also includes transmitter RF circuitry 1332, which may include filters, modulators, constellation mappers, and so on.

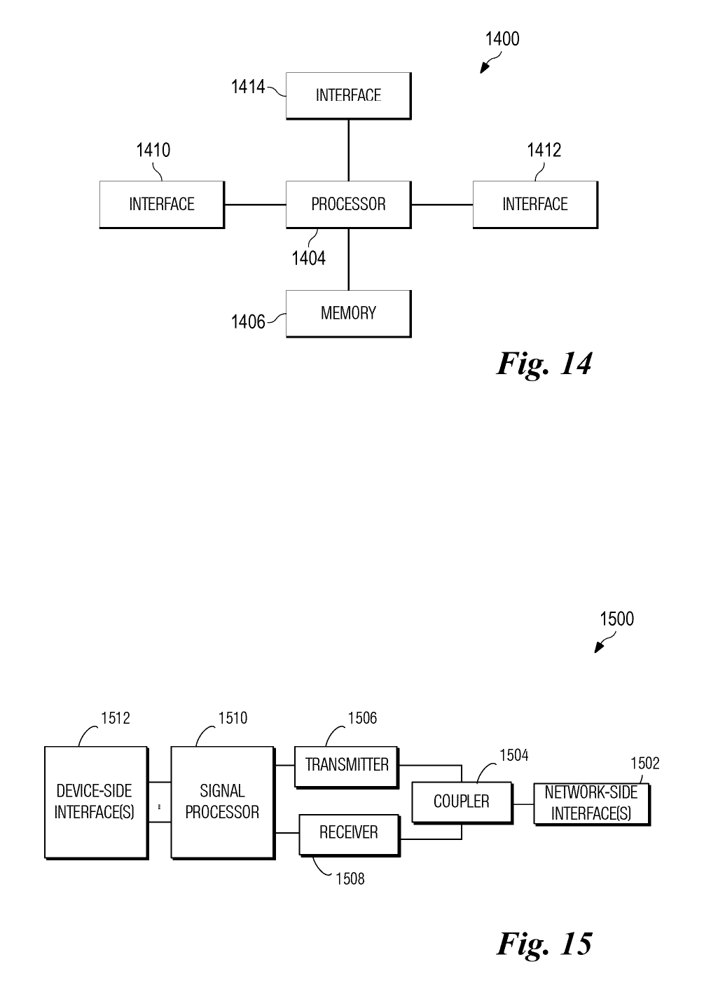

FIG. 14 illustrates a block diagram of an embodiment processing system 1400 for performing methods described herein, which may be installed in a host device. As shown, the processing system 1400 includes a processor 1404, a memory 1406, and interfaces 1410 - 1414, which may (or may not) be arranged as shown in FIG. 14. The processor 1404 may be any component or collection of components adapted to perform computations and/or other processing related tasks, and the memory 1406 may be any component or collection of components adapted to store programming and/or instructions for execution by the processor 1404. In an embodiment, the memory 1406 includes a non-transitory computer readable medium. The interfaces 1410, 1412, 1414 may be any component or collection of components that allow the processing system 1400 to communicate with other devices/components and/or a user. For example, one or more of the interfaces 1410, 1412, 1414 may be adapted to communicate data, control, or management messages from the processor 1404 to applications installed on the host device and/or a remote device. As another example, one or more of the interfaces 1410, 1412, 1414 may be adapted to allow a user or user device (e.g., personal computer (PC), etc.) to interact/communicate with the processing system 1400. The processing system 1400 may include additional components not depicted in FIG. 14, such as long term storage (e.g., non-volatile memory, etc.).

In some embodiments, the processing system 1400 is included in a network device that is accessing, or part otherwise of, a telecommunications network. In one example, the processing system 1400 is in a network-side device in a wireless or wireline telecommunications network, such as a base station, a relay station, a scheduler, a controller, a gateway, a router, an applications server, or any other device in the telecommunications network. In other embodiments, the processing system 1400 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1410, 1412, 1414 connects the processing system 1400 to a transceiver adapted to transmit and receive signaling over the telecommunications network. FIG. 15 illustrates a block diagram of a transceiver 1500 adapted to transmit and receive signaling over a telecommunications network. The transceiver 1500 may be installed in a host device. As shown, the transceiver 1500 comprises a network-side interface 1502, a coupler 1504, a transmitter 1506, a receiver 1508, a signal processor 1510, and a device-side interface 1512. The network-side interface 1502 may include any component or collection of components adapted to transmit or receive signaling over a wireless or wireline telecommunications network. The coupler 1504 may include any component or collection of components adapted to facilitate bi-directional communication over the network-side interface 1502. The transmitter 1506 may include any component or collection of components (e.g., up-converter, power amplifier, etc.) adapted to convert a baseband signal into a modulated carrier signal suitable for transmission over the network-side interface 1502. The receiver 1508 may include any component or collection of components (e.g., down-converter, low noise amplifier, etc.) adapted to convert a carrier signal received over the network-side interface 1502 into a baseband signal. The signal processor 1510 may include any component or collection of components adapted to convert a baseband signal into a data signal suitable for communication over the device-side interface(s) 1512, or vice-versa. The device-side interface(s) 1512 may include any component or collection of components adapted to communicate data-signals between the signal processor 1510 and components within the host device (e.g., the processing system 1400, local area network (LAN) ports, etc.).

The transceiver 1500 may transmit and receive signaling over any type of communications medium. In some embodiments, the transceiver 1500 transmits and receives signaling over a wireless medium. For example, the transceiver 1500 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1502 comprises one or more antenna/radiating elements. For example, the network-side interface 1502 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1500 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

Although the present disclosure and its advantages have been described in detail, it should be understood that various changes, substitutions and alterations can be made herein without departing from the spirit and scope of the disclosure as defined by the appended claims.

1. A method for operating a large scale multiple input multiple output (MIMO) communications device adapted to perform large scale MIMO communications, the method comprising:
determining positional information of antennas of an antenna array, comprising measuring times of arrivals of orthogonal reference signals transmitted by at least four reference signal generators;
determining channel gains for channels between the antennas of the antenna array and a second communications device in accordance with the positional information of the antennas of the antenna array and directional information of the second communications device;
determining beamforming coefficients for the antennas of the antenna array in accordance with the channel gains, the positional information of the antennas of the antenna array, and the directional information of the second communications device with which the large scale MIMO communications device is communicating;
applying the beamforming coefficients to the antennas of the antenna array; and
communicating with the second communications device using the antenna array.

2. The method of claim 1, wherein determining the beamforming coefficients comprises:
determining the directional information of the second communications device.

3. The method of claim 2, further comprising:
performing acquisition to derive the directional information of the second communications device.

4. The method of claim 3, wherein performing acquisition comprises:
measuring received energy levels in portions of a search space using antenna beams generated by independent antenna arrays partitioned from the antenna array, wherein each independent antenna array is assigned to at least one portion of the search space; and
selecting received energy levels meeting a specified threshold, thereby producing the directional information.

5. The method of claim 2, wherein determining the positional information comprises:
for each antenna of the antenna array,
measuring times of arrivals of orthogonal reference signals transmitted by reference signal generators, and
deriving the positional information of the antenna in accordance with the times of arrivals.

6. The method of claim 5, wherein deriving the positional information of the antenna comprises solving:
c²·(τₘ⁰−tₘ)²=(X₀−xₘ)²+(Y₀−yₘ)²+(Z₀−zₘ)²
c²·(τₘ¹−tₘ)²=(X₁−xₘ)²+(Y₁−yₘ)²+(Z₁−zₘ)²
c²·(τₘ²−tₘ)²=(X₂−xₘ)²+(Y₂−yₘ)²+(Z₂−zₘ)^{2′}
c²·(τₘ³−tₘ)²=(X₃−xₘ)²+(Y₃−yₘ)²+(Z₃−zₘ)²
for (xₘ, yₘ, zₘ) and tₘ, where m identifies the antenna, for m=1, 2, 3, and 4, where (Xₖ, Yₖ, Zₖ) are coordinates of a k-th reference signal generator, (xₘ, yₘ, zₘ) are coordinates of the antenna, tₘ is a time offset of the antenna, τₘ^{k} is a time of arrival of an orthogonal reference signal transmitted by the k-th reference signal generator at the antenna, for k=0, 1, 2, and 3, and c is the speed of light.

7. (canceled)

8. The method of claim 1, wherein determining the channel gains comprises evaluating
$${\overline{H}}_{p} ( α , β ) = exp ( j \cdot 2 \cdot π \cdot \frac{\begin{matrix}( {x}_{p} - {x}_{0} ) \cdot cos ( α ) \cdot cos ( β ) + \\ ( {y}_{p} - {y}_{0} ) \cdot cos ( α ) \cdot sin ( β ) + ( {z}_{p} - {z}_{0} ) \cdot sin ( α )\end{matrix}}{λ} )$$
where (α, β) is the directional information, (xₚ, yₚ, zₚ) is the positional information of a p-th antenna of the antenna array, (x₀, y₀, z₀) is a reference position, and A is a wavelength of a carrier wave.

9. The method of claim 1, wherein the antenna array is a non-planar antenna array with irregular antenna spacing.

10. A large scale multiple input multiple output (MIMO) communications device comprising:
an antenna array;
a processor; and
a non-transitory computer readable storage medium storing programming for execution by the processor, the programming including instructions configuring the large scale MIMO communications device to:
determine positional information of antennas of an antenna array, comprising instructions to measure times of arrivals of orthogonal reference signals transmitted by at least four reference signal generators,
determine channel gains for channels between antennas of the antenna array and a second communications device in accordance with the positional information of the antennas of the antenna array and directional information of the second communications device,
determine beamforming coefficients for the antennas of the antenna array in accordance with the channel gains, the positional information of the antennas of the antenna array and the directional information of the second communications device with which the large scale MIMO communications device is communicating,
apply the beamforming coefficients to the antennas of the antenna array, and
communicate with the second communications device using the antenna array.

11. The large scale MIMO communications device of claim 10, wherein the programming includes instructions to determine the directional information of the second communications device.

12. The large scale MIMO communications device of claim 11, wherein the programming includes instructions to perform acquisition to derive the directional information of the second communications device.

13. The large scale MIMO communications device of claim 12, wherein the programming includes instructions to measure received energy levels in portions of a search space using antenna beams generated by independent antenna arrays partitioned from the antenna array, wherein each independent antenna array is assigned to at least one portion of the search space, and select received energy levels meeting a specified threshold, thereby producing the directional information.

14. The large scale MIMO communications device of claim 11, wherein the programming includes instructions to, for each antenna of the antenna array, measure times of arrivals for reference signals transmitted by reference signal generators, and derive the positional information of the antenna in accordance with the times of arrivals.

15. The large scale MIMO communications device of claim 14, wherein the programming includes instructions to solve:
c²·(τₘ⁰−tₘ)²=(X₀−xₘ)²+(Y₀−yₘ)²+(Z₀−zₘ)²
c²·(τₘ¹−tₘ)²=(X₁−xₘ)²+(Y₁−yₘ)²+(Z₁−zₘ)²
c²·(τₘ²−tₘ)²=(X₂−xₘ)²+(Y₂−yₘ)²+(Z₂−zₘ)^{2′}
c²·(τₘ³−tₘ)²=(X₃−xₘ)²+(Y₃−yₘ)²+(Z₃−zₘ)²
for (xₘ, yₘ, zₘ) and tₘ, where m identifies the antenna, for m=1, 2, 3, and 4, where (Xₖ, Yₖ, Zₖ) are coordinates of a k-th reference signal generator, (xₘ, yₘ, zₘ) are coordinates of the antenna, tₘ is a time offset of the antenna, τₘ^{k} is a time of arrival of a reference signal transmitted by the k-th reference signal generator at the antenna, for k=0, 1, 2, and 3, and c is the speed of light.

16. (canceled)

17. The large scale MIMO communications device of claim 10, wherein the antenna array is disposed on a surface of a lighter than air airship.

18. A large scale multiple input multiple output (MIMO) communications system comprising:
a positioning system comprising at least four reference signal generators, configured to transmit orthogonal reference signals; and
a large scale MIMO communications device including:
an antenna array comprising a plurality of antenna units,
a processor, and
a non-transitory computer readable storage medium storing programming for execution by the processor, the programming including instructions configuring the large scale MIMO communications system for:
determining positional information of antenna units of the antenna array in accordance with the orthogonal reference signals transmitted by the at least four reference signal generators the positioning system,
determining channel gains for channels between antennas of the antenna array and a second communications device in accordance with the positional information of the antenna units of the antenna array and directional information of the second communications device,
determining beamforming coefficients for the antenna units of the antenna array in accordance with the channel gains, the positional information and the directional information of the second communications device operating in a coverage area of the large scale MIMO communications system,
applying the beamforming coefficients to the antenna units of the antenna array, and
communicating with the second communications device using the antenna array.

19. The large scale MIMO communications system of claim 18, wherein the positioning system comprises a plurality of reference signal generators, each reference signal generator configured to transmit an orthogonal reference signal.

20. The large scale MIMO communications system of claim 18, wherein the antenna array is disposed on a surface of a lighter than air airship.

21. The large scale MIMO communications system of claim 20, further comprising a locating system operatively coupled to the positioning system, the locating system configured to determine a location of the antenna array and to provide location information of the antenna array to the positioning system.

22. The large scale MIMO communications system of claim 18, wherein the antenna array is a non-planar antenna array with irregular antenna unit spacing.

23. The large scale MIMO communications system of claim 18, wherein the positioning system comprises:
a first reference signal generator at a first location, wherein the first reference signal generator is configured to transmit a first reference signal, and
a second reference signal generator at a second location, wherein the second reference signal generator is configured to transmit a second reference signal, wherein the first location is different than the second location, and wherein the first reference signal is orthogonal to the second reference signal.

24. The method of claim 5, wherein the reference signal generators comprise a first reference signal generator at a first location generating a first reference signal and a second reference signal generator at a second location generating a second reference signal, wherein the first location is different than the second location, and wherein the first reference signal is orthogonal to the second reference signal.
